(19) United States
(12) Patent Application Publication
(10) Pub. No.: US 2014/0373298 A1
(43) Pub. Date: Dec. 25, 2014

(54) AIRFOIL FOR HYBRID WIPER ASSEMBLY

(71) Applicant: TRICO PRODUCTS CORPORATION, Rochester Hills, MI (US)

(72) Inventor: John Foss, Troy, MI (US)

(21) Appl. No.: 13/926,182

(22) Filed: Jun. 25, 2013

(51) Int. Cl. B60S 1/38

(52) U.S. Cl. CPC B60S 1/381
USPC 15/250.201; 416/223 R

(57) ABSTRACT

An airfoil for a hybrid wiper assembly includes an airfoil for a hybrid wiper assembly including a body extending longitudinally and having a spoiler that tapers outwardly from the body toward a terminal point to define a varying profile along a longitudinal curved surface thereof. The airfoil also includes a plurality of inwardly extending claws extending longitudinally and forming grooves between the body and the claws near each longitudinal end thereof and adapted to receive support structure of the hybrid wiper assembly.

### BACKGROUND OF THE INVENTION

1. Field of the Invention

The present invention relates generally to wiper assemblies for vehicles and, more specifically, to an airfoil for a hybrid wiper assembly of a vehicle.

2. Description of the Related Art

Conventional wiper assemblies for vehicles known in the related art include some type of wiper assembly mounted to a wiper arm which, in turn, is mounted adjacent a surface to be wiped such as a windshield of the vehicle and pivotally driven to impart reciprocal motion to the wiper assembly across the windshield. The wiper assembly typically includes a rubber wiping element that contacts the windshield across the surface to be wiped. The wiper assembly often incorporates one or more metal strips which act to reinforce the wiping element and facilitate wiping contact by the wiping element across what is typically a curved glass surface. In this context, the wiper arm delivers a downward force to the wiper assembly that is distributed thereacross pressing the wiper assembly into contact with the windshield. The wiper assembly may also include an airfoil and a pair of end caps located at the distal ends of the wiper assembly.

Current state of the art wiper strategies require an airfoil to prevent the wiping element from lifting off the surface to be wiped. In some cases, the airfoil has two diverging legs, which are connected to each other by a common base. The free ends of the legs are oriented toward the surface to be wiped and are supported by the wiper assembly. The airfoil also has a surface on the outside of the one leg and the relative wind chiefly flows against this surface during operation. The airfoil is typically made of a light weight elastic material.

Some conventional wiper assemblies use an airfoil that is captured between end caps to hold the airfoil in place. However, this creates extra components and cost. Therefore, there s need in the art for an airfoil for a wiper assembly that forms a hybrid wiper assembly to allow the airfoil to both distribute the down force from aerodynamic wind loading and eliminate the need for end caps on the wiper assembly.

### SUMMARY OF THE INVENTION

The present invention overcomes the disadvantages in the related art in an airfoil for a hybrid wiper assembly including a body extending longitudinally and having a spoiler that tapers outwardly from the body toward a terminal point to define a varying profile along a longitudinal curved surface thereof. The airfoil also includes a plurality of laterally inwardly extending claws forming grooves between the body and the claws near each longitudinal end thereof at d adapted to receive support structure of the hybrid wiper assembly.

In addition, the present invention is a hybrid wiper assembly including a wiping element adapted to contact a surface to be wiped. The hybrid wiper assembly also includes at least one elongated beam defining a longitudinal axis, the beam acting to support the wiping element. The hybrid wiper assembly further includes an airfoil operatively mounted to the beam. The airfoil includes a body extending longitudinally and having a spoiler that tapers outwardly from the body toward a terminal point to define a varying profile along a longitudinal curved surface thereof, and a plurality of laterally inwardly extending claws forming grooves between the body and the claws near each longitudinal end thereof to receive the beam.

One advantage of the present invention is that the hybrid wiper assembly eliminates end caps for improved resistance to ice scraper damage. Another advantage of the present invention is that the hybrid wiper assembly has a sleek aesthetically pleasing stylized design. Yet another advantage of the present invention is that the hybrid wiper assembly has fewer parts than conventional wiper assemblies. Still another advantage of the present invention is that the hybrid wiper assembly has easy installation. A further advantage of the present invention is that the hybrid wiper assembly keeps assembly costs and warranty complexity in check by reducing total part count. Yet a further advantage of the present invention is that the hybrid wiper assembly has a significant improvement in A-pillar drawback. Still a further advantage of the present invention is that the hybrid wiper assembly of the present invention can be used for wiper systems in any type of transportation from automotive vehicles, heavy-duty trucks, trains, air planes, ships, large construction vehicles, or military vehicles or any other type of vehicle that contains surface wiper systems.

Other objects, features and advantages of the present invention will be readily appreciated as the same becomes better understood after reading the subsequent description taken in connection with the accompanying drawings.

### BRIEF DESCRIPTION OF THE DRAWINGS

FIG. 1 is a partial perspective view of a front of a vehicle having a pair of hybrid wiper assemblies, according to one embodiment of the present invention, pivotally mounted for reciprocal movement across a windshield of the vehicle.

FIG. 2 is an enlarged perspective view of one of the hybrid wiper assemblies of FIG. 1, according to one embodiment of the present invention, removed from a wiper arm.

FIG. 3 is a cross-sectional view of the hybrid wiper assembly of FIG. 2.

FIG. 4 is a front elevational view of the hybrid wiper assembly of FIG. 2, according to one embodiment of the present invention.

FIG. 5 is one side devotional view of the hybrid wiper assembly of FIG. 2, according to one embodiment of the present invention.

FIG. 6 is the opposite side elevational view of the hybrid wiper assembly of FIG. 2, according to one embodiment of the present invention.

FIG. 7 is a bottom view of the hybrid wiper assembly of FIG. 2, according to one embodiment of the present invention.

FIG. 7A is an enlarged view of a portion of the hybrid wiper assembly illustrated in circle 7A of FIG. 7.

FIG. 8 is a top view of the hybrid wiper assembly of FIG. 2, according to one embodiment of the present invention.

FIG. 9 is a sectional view taken along line 9-9 of FIG. 8.

FIG. 10 is a bottom view of another embodiment of an airfoil, according to the present invention, of the hybrid wiper assembly of FIG. 2.

FIG. 11 is a fragmentary front view of the airfoil of FIG. 10, according to one embodiment of the present invention.

FIG. 12 is an enlarged view of a portion of the airfoil illustrated in circle 12 of FIG. 11.

FIG. 13 is a sectional view taken along line 13-13 of FIG. 12.

FIG. 14 is a sectional view taken along line 14-14 of FIG. 12.

### DETAILED DESCRIPTION OF THE PREFERRED EMBODIMENT(S)

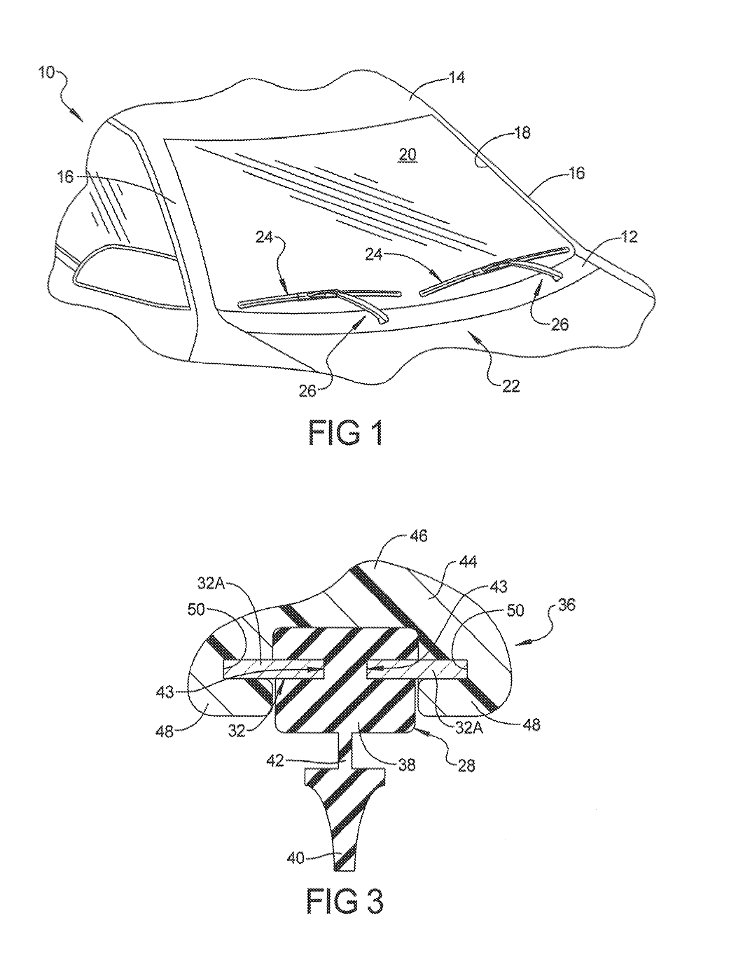

Referring now to the figures, where like numerals are used to designate like structure, a portion of a vehicle is illustrated at 10 in FIG. 1. The portion of the vehicle 10 includes a body having a cowl 12, a roof 14, and a pair of laterally spaced front or “A” pillars 16 extending between the roof 14 and the cowl 12. The A-pillars 16, roof 14, and cowl 12 cooperate to define a generally rectangular perimeter opening 18, which supports a curved or “swept back” windshield 20. As illustrated, the vehicle 10 is an automotive vehicle, but may be any type of vehicle such as heavy-duty trucks, trains, air planes, ships, large construction vehicles, or military vehicles or any other type of vehicle that contains surface wiper systems.

A wiper system is generally shown at 22 in FIG. 1 and is employed to clean the windshield 20. In the representative example illustrated herein, the wiper system 22 includes a pair of hybrid wiper assemblies, generally indicated, at 24 and according to the present invention, and which correspond to the driver and passenger side of the vehicle 10. However, those having ordinary skill in the art will appreciate that the wiper system 22 could employ a single hybrid wiper assembly 24 without departing from the scope of the present invention. Each hybrid wiper assembly 24 is carried by a corresponding wiper arm assembly, generally indicated at 26. The wiper arm assembly 26 includes an attachment me bet (not shown but generally known in the art) adapted to operatively engage the hybrid wiper assembly 24. The wiper system 22 further includes an electrical motor (not shown but generally known in the art) typically employed to power the wiper system 22 to move the hybrid wiper assemblies 24 in an oscillating manner across the surface of the windshield 20.

While the hybrid wiper assembly 24 illustrated in FIG. 1 is shown in connection with the front windshield 20 of the vehicle 10, those having ordinary skill in the art will appreciate that the hybrid wiper assemblies 24 may be employed in other areas of the vehicle 10, such as a rear window (not shown) or a head lamp (not shown) that employs a wiper system. Thus, it will be understood that the present invention is not limited for use solely in connection with wiper arm assemblies 26 and wiper assemblies 24 adapted for use on a vehicle's windshield 20, but for use in all applications where wiper arm assemblies 26 and wiper assemblies 24 are employed.

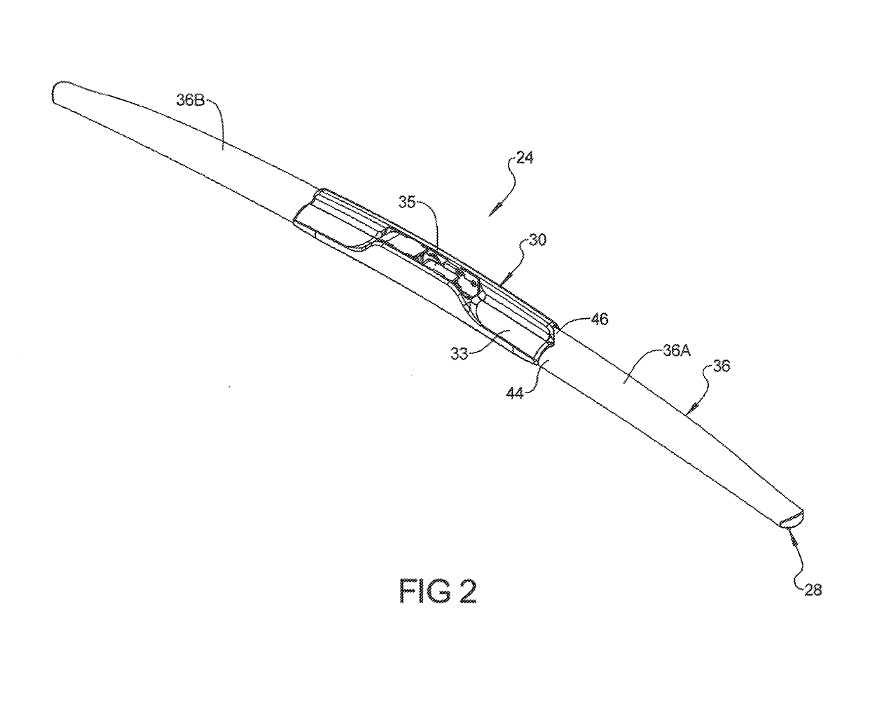

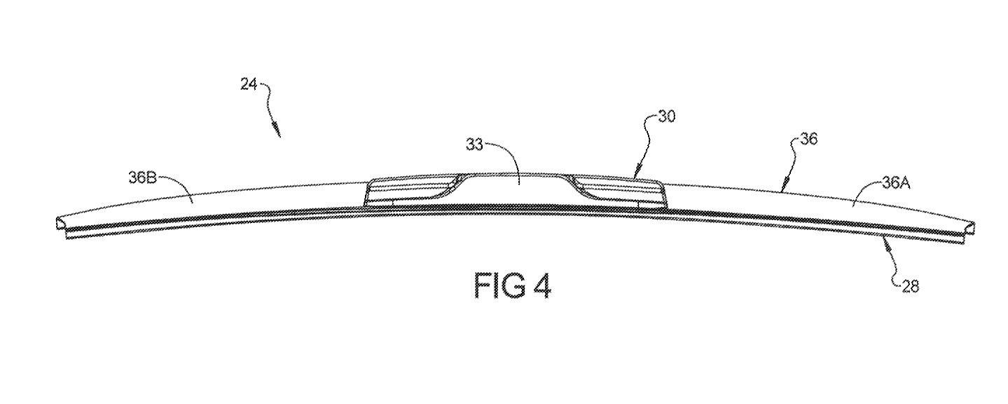

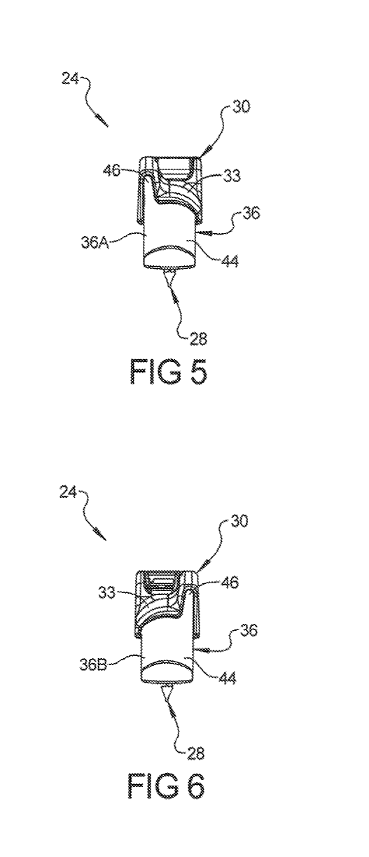

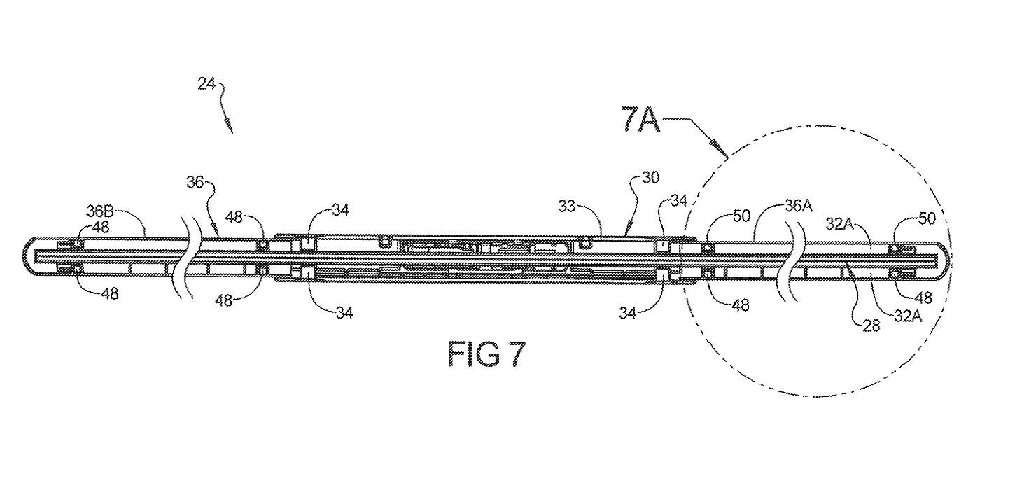

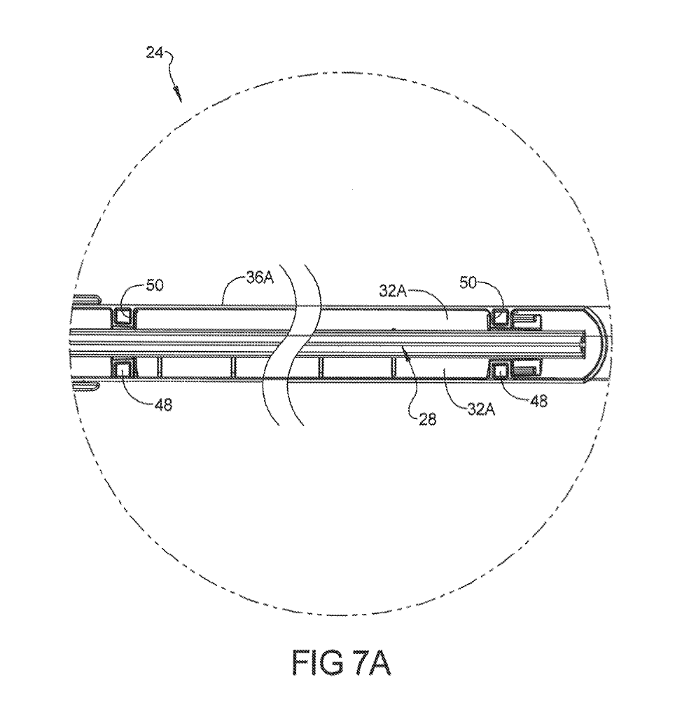

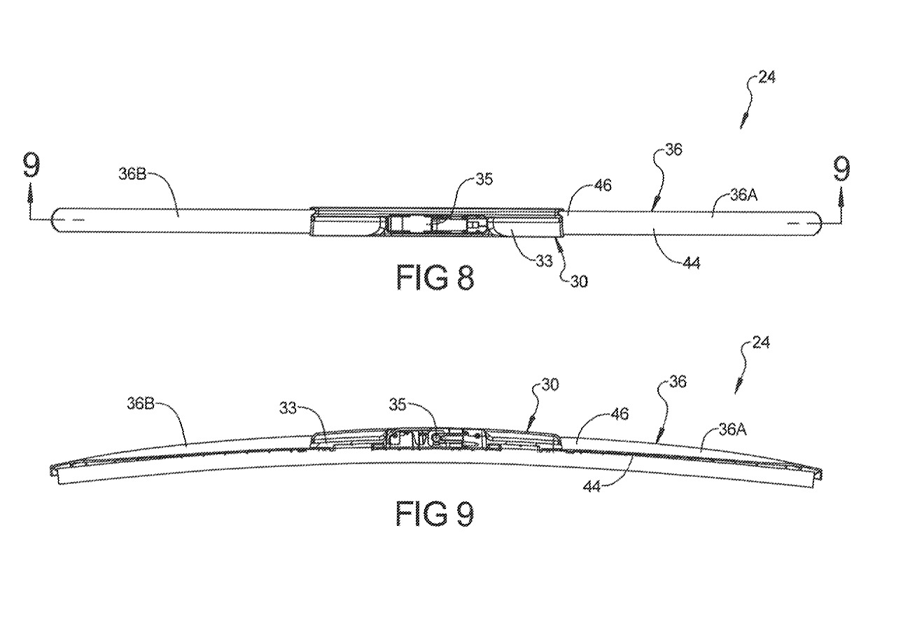

Referring to FIGS. 2 through 9, the hybrid wiper assembly 24 includes a wiping element, generally indicated at 28, that is adapted to contact the surface of the vehicle 10 to be wiped, in this representative example, the windshield 20. In addition, the hybrid wiper assembly 24 generally includes a coupler assembly, generally indicated at 30, that acts to interconnect the wiper arm assembly 26 and the wiping element 28. The hybrid wiper assembly 24 also includes at least one elongated beam, generally indicated at 32, that defines a longitudinal axis and that acts to support the wiping element 28. In the representative embodiment illustrated herein, the beam 32 includes a pair of rails or splines, generally indicated at 32A, that are operatively supported in the wiping element 28. However, those having ordinary skill in the art will appreciate from the description that follows that the beam 32 may be either monolithic or defined by the pair of rails or splines 32A. The hybrid wiper assembly 24 may also include an airfoil, generally indicated at 36, according to one embodiment of the present invention, which will be described in greater detail below.

As best shown in FIG. 3, the wiping element 28 includes an upper section 38 and a lower section 40 that are partitioned by a longitudinally extending bridge portion 42. The bridge portion 42 provides flexibility between the upper section 38 and lower section 40 during operational movement of the wiper assembly 24 across the surface to be wiped. The upper section 38 includes a pair of grooves, generally indicated at 43, extending in the direction of the longitudinal axis of the wiping clement 28. The grooves 43 are disposed on either side of the wiping element 28 and have laterally extending open ends disposed on opposite sides of the wiping element 28 with respect to each other. Each rail 32A is adapted to be received in a snug fashion in a corresponding one of the grooves 43 formed on the upper section 38 of the wiping element 28. The wiping element 28 includes a predetermined length corresponding to particular application and is often manufactured through an extrusion process, which enables the length of the wiping element 28 to be easily adjusted without a substantial increase to manufacturing expense. Furthermore, while the wiping element 28 of the present invention is constructed from a flexible rubber, those having ordinary skill in the art will appreciate that it may be constructed from any flexible material such as silicone or other polymer without departing from the scope of the present invention.

The beam 32 may be constructed from a resiliently flexible material, such as spring steel or a polymer, and is adapted to apply force from an intermediate position between first and second longitudinal ends to the first and second longitudinal ends thereof. More specifically, the beam 32 receives force from the spring-loaded wiper arm assembly 26 at an intermediate position and distributes this three across the span of the beam 32 toward the first and second longitudinal ends. To that end, the beam 32 may be curved longitudinally with a predetermined radius of curvature. This predetermined radius of curvature is sometimes referred to in the related art as a “free form” radius of curvature. Accordingly, the curvature of the beam 32 may be symmetrical or asymmetrical depending on the force requirements and the contour of the windshield 20. The flexible, free form, pre-curved beam 32 straightens out when the wiper arm assembly 26 applies a force thereto to flatten the beam 32 and directs the wiping element 28 to contact the windshield 20. Thus, the elongated beam 32 includes a free-form curvature that ensures force distribution on windshields having various curvatures that effects proper wrapping about the windshield 20.

As illustrated throughout the figures, the beam 32 has a substantially constant width and may have a constant thickness throughout the length between the first and second longitudinal ends. The constant width and thickness are adapted to provide high lateral and torsional stiffness to avoid lateral and torsional deflection, which causes the wiping element 28 to stick/slip (“chatter”) on the windshield 20 during operation. Thus, the cross-section of the beam 32 has a generally rectangular outer profile that makes the elongated beam 32 easier to manufacture. More specifically, where the beam 32 is constructed from metal, such as spring steel, the tools and machinery used to manufacture the beam 32 are less complicated than that required to manufacture having varying widths and/or thicknesses. Furthermore, where the beam 32 is constructed from a polymer, such as a thermoplastic elastomer, the tools and extrusion process machinery are also less complicated than those employed to manufacture beams having varying widths and/or thicknesses. However, those having ordinal skill in the art will appreciate that the beam 32 illustrated herein may include a varying thickness and/or width without departing from the scope of the present invention.

As noted above and as shown in FIGS. 2 through 9, the hybrid wiper assembly 24 also includes a coupler assembly, generally indicated at 30. The coupler assembly 30 is adapted to connect the hybrid wiper assembly 24 to the wiper arm assembly 26. More specifically, the coupler assembly includes a body 33 extending longitudinally and having a plurality of tabs 34 extending laterally inwardly and spaced longitudinally, one set near each longitudinal end thereof. The tabs 34 allow retention of the coupler assembly 30 to the beam 32. The body 33 is made of a plastic material. The body 33 is integral, unitary, and one-piece.

In addition, those having ordinary skill in the art will appreciate that different OEM's employ wiper arm assemblies having different attachment members adapted to operatively engage a specific wiper assembly. Accordingly, the coupler assembly 30 illustrated herein includes structure that operatively engages at least one or more of these different attachment members. Further by way of example, certain wiper arm assemblies employed by OEM's include “bayonet-style”; “pin-type”; or “hook-type” attachment members of various sizes that operatively engage the wiper assemblies. Accordingly, the coupler assembly 30 illustrated herein may include an adapter 35 for operatively engaging at least one or more of these different attachment members for use in connection with the hybrid wiper assemblies 24 without departing from the scope of the present invention.

As previously noted, the hybrid wiper assembly 24 includes the airfoil, generally indicated at 36 and according to one embodiment of the present invention. The airfoil 36 is operatively mounted to the beam 32. The airfoil 36 extends between each of the longitudinal ends of the beam 32. The airfoil 36 acts to reduce the likelihood of wind lift by allowing air to flow over the hybrid wiper assembly 24. More specifically, and in the embodiment illustrated herein, the airfoil 36 includes a pair of airfoil components 36A, 36B that are operatively mounted to the beam 32 and extend between the coupler 30 and each of the longitudinal ends of the beam 32. However, those having ordinary skill in the art will appreciate that the airfoil 36 may be defined by a single unitary component without departing from the scope of the present invention.

Referring to FIGS. 2 through 9, each of the airfoil components 36A, 36B includes a body 44 extending longitudinally. Each of the airfoil components 36A, 36B includes a spoiler 46 that tapers outwardly from the body 44 toward a terminal point to define a varying profile along a longitudinal curved surface. Each of the airfoil components 36A, 36B includes a plurality of inwardly extending legs or claws 48 forming grooves 50 between the body 44 and the claws 48 at each longitudinal end thereof. The grooves 50 are generally rectangular in shape. In the embodiment illustrated, each airfoil component 36A, 36B includes two sets of claws 48, one set near each longitudinal end thereof. The claws 48 extend longitudinally a predetermined distance and laterally inwardly a predetermined distance to form a gap or space therebetween. The claws 48 are generally rectangular in shape. The body 44 is made of plastic material. The body 44 is solid, integral, unitary, and one-piece. In addition, each of the airfoil components 36A, 36B may be manufactured through an injection molding process. However, those having ordinary skill in the art will appreciate that the airfoil 36 may be manufactured using any other conventional mechanism. It should he appreciated that the claws 48 form a four claw system that allows retention to the beam 32 while allowing free vertical travel of the beam 32 on a varying profile longitudinal curved surface. The airfoil 36 is attached on the outboard or longitudinal ends of the beam 32 by the claws 48 that extend into notches 50 in the rails 32A of the beam 32 and lock the physical location of the airfoil 36 relative to the end of the beam 32. The inboard end of the airfoil 36 is tucked under the coupler 30 with a lap interlace. It should be appreciated that any gap that would be caused by tolerance variation in components or opening and closing while riding over curved surfaces in buried under the lap face of the adjoining component and hidden from sight.

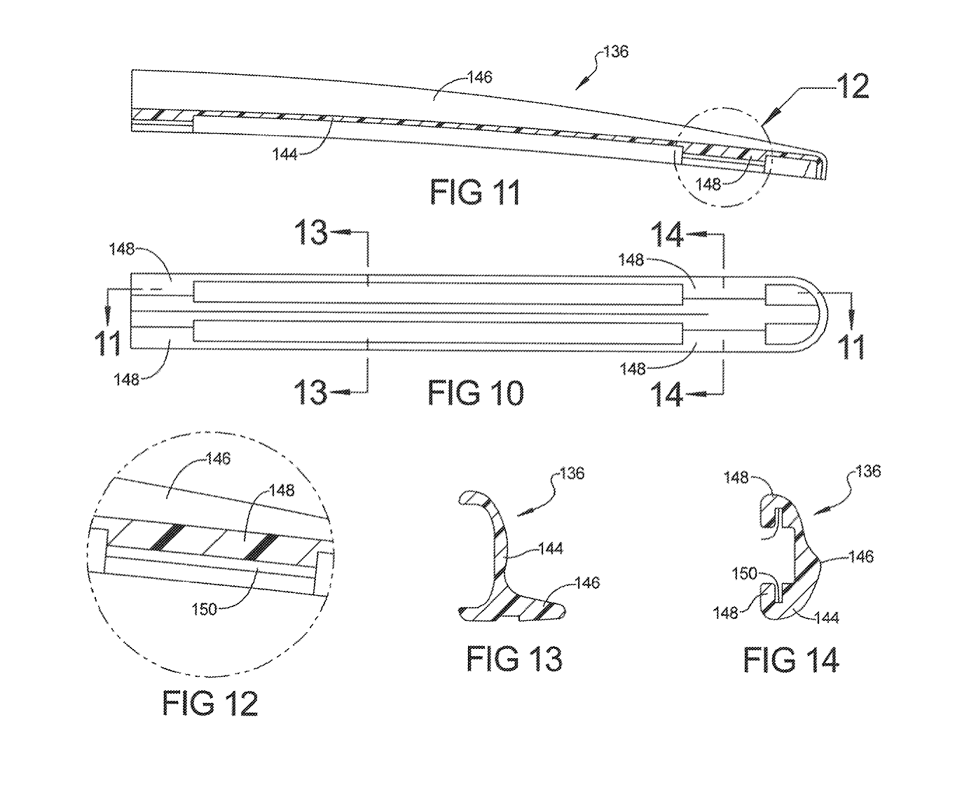

Referring to FIGS. 10 through 14, another embodiment, according to the present invention, of the airfoil 36 is shown. Like parts of the airfoil 36 have like reference numerals increased by one hundred (100). In this embodiment, the airfoil 136 includes a spoiler 146 that tapers outwardly from the body 144 toward a terminal point to define a varying profile along a longitudinal curved surface. The airfoil 136 includes a plurality of inwardly extending legs or claws 148 forming, grooves 150 between the body 144 and the claws 148 at each longitudinal end thereof. In the embodiment illustrated, the airfoil 136 includes two sets of claws 148, one set near each longitudinal end thereof. The claws 148 extend longitudinally a predetermined distance and laterally inwardly a predetermined distance to form a gap or space therebetween. The claws 148 are generally rectangular in shape. The claws 148 extend longitudinally a distance greater than a lateral inwardly distance. In addition, the airfoil 136 may be manufactured through an injection molding process. However, those having ordinary skill in the art will appreciate that the airfoil 136 may be manufactured using any other conventional mechanism. It should be appreciated that the claws 148 form a four claw system that allows retention to the beam 32 while allowing free vertical travel of the beam 32 on a varying profile curved surface.

Accordingly, the hybrid wiper assembly 24 of the present invention is sleek and aesthetically pleasing. The hybrid wiper assembly 24 of the present invention eliminates end caps for a reduction in parts and improved resistance to ice scrapper damage. The hybrid wiper assembly 24 of the present invention has easy installation. The hybrid wiper assembly 24 of the present invention allows infinite loading along the entire longitudinal length of the wiping element 28 while maintaining a wiper spread load input distribution to the learn 32 of the wiper assembly 24. The hybrid wiper assembly 24 of the present invention has the features of a twin point load input from the Win attachment point and a rigid set of airfoils 36 that both distribute the down force from aerodynamic wind loading and eliminate the need for end caps on the wiper assembly 24.

The present invention has been described in an illustrative manner. It is to be understood that the terminology Which has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. An airfoil for a hybrid wiper assembly comprising:
a body extending longitudinally and having a spoiler that tapers outwardly from said body toward a terminal point to define a varying profile along a longitudinal curved surface thereof; and
a plurality o f laterally inwardly extending claws forming grooves between said body and said claws near each longitudinal end thereof and adapted to receive support structure of said hybrid wiper assembly.

2. An airfoil as set forth in claim 1 wherein said claws extend longitudinally a predetermined length less than a length of said airfoil.

3. An airfoil as set forth in claim 1 wherein said claws comprises a pair of opposed claws extending laterally inwardly.

4. An airfoil as set forth in claim 3 wherein said pair of opposed claws form a space therebetween.

5. An airfoil as set forth in claim 1 wherein said claws comprise a pair of opposed claws at one longitudinal end and a pair of opposed claws at the other longitudinal end.

6. An airfoil as set forth in claim 1 wherein said claws extend longitudinally a distance greater than a laterally inwardly distance.

7. An airfoil as set forth in claim 1 wherein said grooves are generally rectangular in shape.

8. An airfoil as set forth in claim 1 wherein said claws are generally rectangular in shape.

9. An airfoil as set forth in claim 1 wherein said body is solid, integral, unitary, and one-piece.

10. An airfoil as set forth in claim 1 wherein said body is made of a plastic material.

11. A hybrid wiper assembly comprising:
a wiping element adapted to contact a surface to be wiped;
at least one elongated beam defining a longitudinal axis, said beam acting to support said wiping element and having opposed longitudinal ends;
an airfoil operatively mounted to said beam and extending between said longitudinal ends of said beam; and
said airfoil comprising a body extending longitudinally and having a spoiler that tapers outwardly from said body toward a terminal point to define a varying profile along a longitudinal curved surface thereof, and a plurality of laterally inwardly extending claws forming grooves between said body and said claws near each longitudinal end thereof to receive said beam.

12. A wiper assembly as set forth in claim 11 wherein said claws extend longitudinally a predetermined length less than a length of said airfoil.

13. A wiper assembly as set forth in claim 11 wherein said claws comprises a pair of opposed claws extending laterally.

14. A wiper assembly as set forth in claim 13 wherein said pair of opposed claws form a space therebetween.

15. A wiper assembly as set forth in claim 11 wherein said claws comprise a pair of opposed claws at one longitudinal end and a pair of opposed claws at the other longitudinal end.

16. A wiper assembly as set forth in claim 11 wherein said claws extend longitudinally a distance greater than a laterally inwardly distance.

17. A wiper assembly as set forth in claim 11 wherein said claws are generally rectangular in shape.

18. A wiper assembly as set forth in claim 11 wherein said body is solid, integral, unitary, and one-piece.

19. A wiper assembly as set forth in claim 11 wherein said body is made of a plastic material.

20. A hybrid wiper assembly for a windshield of a vehicle comprising:
a wiping element adapted to contact a surface to be wiped;
at least one elongated beam defining a longitudinal axis, said beam acting to support said wiping element and having opposed longitudinal ends;
a pair of airfoils operatively mounted to said beam and extending between said longitudinal ends of said beam;
each of said air foils comprising a body extending longitudinally and having a spoiler that tapers outwardly from said body toward a terminal point to define as varying profile along a longitudinal curved surface thereof, and a plurality of laterally inwardly extending claws extending longitudinally and forming grooves between said body and said claws near each longitudinal end thereof to receive said beam.
